(19) United States
(12) Patent Application Publication
(10) Pub. No.: US 2026/0100550 A1
(43) Pub. Date: Apr. 9, 2026

(54) High Voltage Connector And Power Supply Apparatus

(71) Applicant: VERTIV CORPORATION, Westerville, OH (US)

(72) Inventors: Zhongchang SUN, Shenzhen (CN); Renliang WANG, Shenzhen (CN); Tongru FU, Shenzhen (CN)

(73) Assignee: VERTIV CORPORATION, Westerville, OH (US)

(21) Appl. No.: 19/294,916

(22) Filed: Aug. 8, 2025

(30) Foreign Application Priority Data
Oct. 9, 2024 (CN) 202422426993.0

(51) Int. Cl. H01R 13/713; H01H 47/18

(52) U.S. Cl. CPC H01R 13/713; H01H 47/18

(57) ABSTRACT

A high voltage connector and a power supply apparatus are provided, implementing safety power-off of a device. The high voltage connector includes a first connection part provided with a first power pin module and a first signal pin module, and a second connection part provided with a second power pin module and a second signal pin module. The first connection part is connected to the second connection part in a pluggable manner. A length of a signal pin in the first signal pin module is less than a length of a power pin in the first power pin module. A length of the signal pin in the second signal pin module is less than a length of a power pin in the second power pin module.

### CROSS-REFERENCE TO RELATED APPLICATION

This application claims priority to Chinese Patent Application No. 202422426993.0, filed on Oct. 9, 2024, the entire disclosure of which is incorporated herein by reference.

### FIELD

The present disclosure relates to the technical field of power electronics, and in particular to a high voltage connector and a power supply apparatus.

### BACKGROUND

With the wide application of high voltage power systems, high voltage connectors play an important role in power transmission and power distribution. High voltage connectors are used to connect and disconnect high voltage cables to ensure normal operation of the power system. However, safety when operating high voltage connectors has always been a key concern in the electricity industry.

In high voltage power systems, the method for safely powering off the high voltage connectors is crucial. Directly disconnecting the main circuit electrical connection by unplugging the high voltage connector brings great safety hazards, such as failing to effectively prevent arc generation in the power off process, resulting in device damage or the risk of electric shock to personnel. Especially when the high voltage connector is disconnected, if the arc and current are not effectively controlled, it may cause serious damage to the operator and devices.

### SUMMARY

A high voltage connector and a power supply apparatus are provided according to the present disclosure, to implement safe power-off of a device and protect the safety of the device.

In a first aspect, a high voltage connector is provided according to embodiments of the present disclosure. The high voltage connector is applicable to high-voltage power supply scenarios and is configured to implement safe power-off of a device. The high voltage connector includes at least a first connection part and a second connection part. The first connection part is provided with a first power pin module and a first signal pin module, and a second connection part is provided with a second power pin module and a second signal pin module. The first connection part is connected to the second connection part in a pluggable manner.

Specifically, a first terminal of the first power pin module is configured to be connected to a first power supply through a switch module, a second terminal of the first power pin module is connected to a first terminal of the second power pin module, a first terminal of the first signal pin module is configured to be connected to a driving circuit of the switch module, a second terminal of the first signal pin module is connected to a first terminal of the second signal pin module, and a length of a signal pin in the first signal pin module is less than a length of a power pin in the first power pin module; and a second terminal of the second power pin module is configured to be connected to a load, second terminals of all signal pins in the second signal pin module are directly connected, a length of the signal pin in the second signal pin module is less than a length of a power pin in the second power pin module.

With the above design, generally, the first power supply and the load are respectively arranged on two different PCB boards. The electrical connection between the two PCB boards may be implemented by controlling the pluggable connection between the first connection part and the second connection part. When the first connection part is connected to the second connection part in a pluggable manner, since the length of the signal pin in the first signal pin module is less than the length of the power pin in the first power pin module, the power pins in the first power pin module and the power pins in the second power pin module are connected first to close a main circuit, and then the signal pins in the first signal pin module and the signal pins in the second signal pin module are connected to supply power to the driving circuit, so as to drive the switch module to be turned on. That is, delay power-on is implemented by setting a length difference between the power pin and signal pin, ensuring that the main circuit is closed after the high voltage connector is connected firmly, thereby realizing safe connection of the high voltage connector. When the first connection part is disconnected from the second connection part, since the length of the signal pin in the first signal pin module is less than the length of the power pin in the first power pin module, the signal pins in the first signal pin module and the signal pins in the second signal pin module are disconnected first, the switch module breaks connection of the high-power main circuit since the driving circuit is powered off, and then the power pins in the first power pin module and the power pins in the second power pin module are disconnected, realizing the disconnection of the high-power main circuit by low-power components. The power-off of the high-power main circuit is controlled in the above manner rather than by unplugging directly, thus preventing the generation of arc and ensuring the safety of the main circuit.

In a possible design, the first signal pin module includes a first signal pin and a second signal pin.

Specifically, a first terminal of the first signal pin is configured to be connected to the driving circuit of the switch module, and a second terminal of the first signal pin is connected to the second signal pin module. A first terminal of the second signal pin is configured to be connected to the driving circuit of the switch module, and a second terminal of the second signal pin is connected to the second signal pin module. The first terminal of the first signal pin and the first terminal of the second signal pin form the first terminal of the first signal pin module, and the second terminal of the first signal pin and the second terminal of the second signal pin form the second terminal of the first signal pin module.

In a possible design, the second signal pin module includes a third signal pin and a fourth signal pin.

Specifically, a first terminal of the third signal pin is connected to the second terminal of the first signal pin, and a second terminal of the third signal pin is connected to a second terminal of the fourth signal pin. A first terminal of the fourth signal pin is connected to the second terminal of the second signal pin. The first terminal of the third signal pin and the first terminal of the fourth signal pin form the first terminal of the second signal pin module, and the second terminal of the third signal pin and the second terminal of the fourth signal pin form the second terminal of the second signal pin module.

In a possible design, the first power pin module includes first power pins one-to-one corresponding to all phase lines connected to the first power supply, the second power pin module includes second power pins one-to-one corresponding to all power ports of the load, and the number of the first power pins in the first power pin module is the same as the number of the second power pins in the second power pin module.

In a possible design, the first connection part is located on a first PCB board where the first power supply is located, and the second connection part is located on a second PCB board where the load is located.

In a second aspect, a power supply apparatus is provided in embodiments of the present disclosure. The power supply apparatus includes a first power supply, a switch module, a driving circuit and the high voltage connector provided in the first aspect of the embodiments of the present disclosure and any of possible designs thereof.

The first power supply is connected to the high voltage connector through the switch module. The high voltage connector is connected to the driving circuit. The driving circuit is connected to the switch module and is configured to control turn on and off of the switch module.

In a possible design, the switch module includes a plurality of relays or a plurality of switching transistors.

In a possible design, the driving circuit includes a second power supply, and the second power supply is connected to control terminals of the switching transistors or coils of the relays in the switch module through the first signal pin module.

In a possible design, the power supply apparatus further includes a timer. The second power supply is connected to the first signal pin module through the timer, and an output terminal of the timer is connected to the control terminals of the switching transistors in the switch module. With the above designs, when the signal pins in the first signal pin module and the signal pins in the second signal pin module are connected, the timer drives the switch module to turn on after a time delay, and electrical connection of the main circuit is implemented. Therefore, power-on may be performed in the state that the first power pin module and the second power pin module are connected and the connection is firm, avoiding the safety problems caused by powering on when the first power pin module and the second power pin module are in poor contact

In a possible design, the power supply apparatus further includes a time-delay relay. The second power supply is connected to the first signal pin module through the time-delay relay, and a delay contact of the time-delay relay is connected between the second power supply and the coils of the relays in the switch module. With the above designs, when the signal pins in the first signal pin module and the signal pins in the second signal pin module are connected, the time-delay relay drives the switch module to turn on after a time delay after being powered on, and electrical connection of the main circuit is implemented. Therefore, power-on may be performed in the state that the first power pin module and the second power pin module are connected and the connection is firm, avoiding the safety problems caused by powering on when the first power pin module and the second power pin module are in poor contact.

In a possible design, the power supply apparatus further includes a mechanical switch connected between the second power supply and the first signal pin module. With the above designs, a connection state of the high voltage connector automatically controls a connection sequence of the high voltage connector. In order to avoid failing to break the connection of the main circuit in time caused by the malfunction of the line, the mechanical switch that can be used to manually disconnect the electrical connection of the main circuit is configured, for example, a button switch. When the operator finds that the line has a fault, the operator may press the button switch, to stop the driving signal triggering the switching transistors or the control of the power-on of the coils of the relays, so as to break the electrical connection of the main circuit and protect the safety of the system.

In addition, the technical effect achieved by the second aspect and any of the possible designs thereof can be referred to the technical effect achieved by the various designs in the first aspect of the embodiments of the present disclosure, which will not be repeated here.

### BRIEF DESCRIPTION OF THE DRAWINGS

In order to more clearly illustrate the technical solutions in the embodiments of the present disclosure, the drawings to be used in the description of the embodiments are described briefly below. Apparently, the drawings in the following description show only some embodiments of the present disclosure, and those skilled in the art may obtain other drawings based on these drawings without any creative effort.

FIG. 1 is a first schematic structural diagram of a high voltage connector according to an embodiment of the present disclosure;

FIG. 2 is a second schematic structural diagram of a high voltage connector according to an embodiment of the present disclosure;

FIG. 3 is a first schematic diagram of connection of a high voltage connector according to an embodiment of the present disclosure;

FIG. 4 is a second schematic diagram of connection of a high voltage connector according to an embodiment of the present disclosure;

FIG. 5 is a third schematic diagram of connection of a high voltage connector according to an embodiment of the present disclosure;

FIG. 6 is a first schematic diagram of plugging connection between a first connection part and a second connection part according to an embodiment of the present disclosure;

FIG. 7 is a second schematic diagram of plugging connection between a first connection part and a second connection part according to an embodiment of the present disclosure;

FIG. 8 is a fourth schematic diagram of connection of a high voltage connector according to an embodiment of the present disclosure;

FIG. 9 is a fifth schematic diagram of connection of a high voltage connector according to an embodiment of the present disclosure;

FIG. 10 is a sixth schematic diagram of connection of a high voltage connector according to an embodiment of the present disclosure;

FIG. 11 is a seventh schematic diagram of connection of a high voltage connector according to an embodiment of the present disclosure; and

FIG. 12 is an eighth schematic diagram of connection of a high voltage connector according to an embodiment of the present disclosure.

### DETAILED DESCRIPTION

The application scenarios of the technical solutions according to the embodiments of the present disclosure will be described as follows in conjunction with the drawings in the embodiments of the present disclosure.

The high voltage connector provided in the embodiments of the present disclosure may be used in a high voltage power supply system. Generally, an electric power supply and a load are located on different PCB boards. The high voltage connector can implement the electrical connection between the two PCB boards, and then implement the connection between the electric power supply and the load.

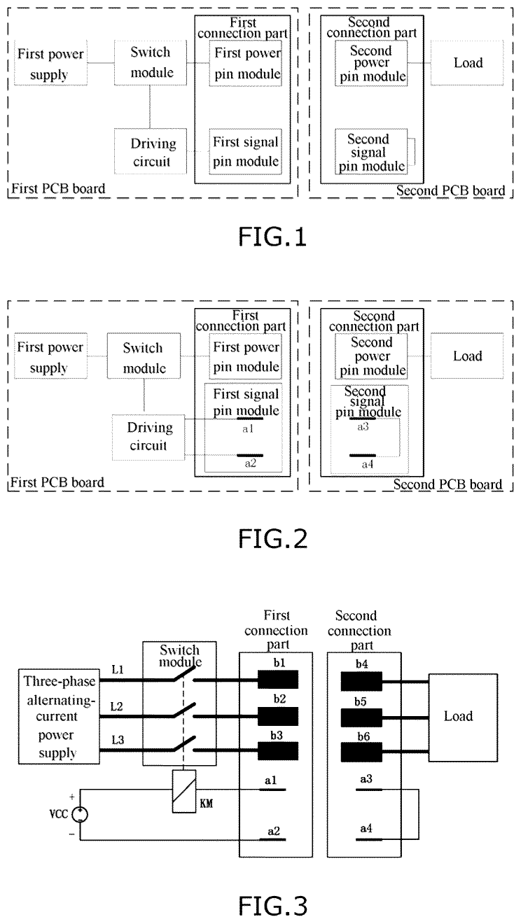

Referring to FIG. 1, FIG. 1 is a schematic structural diagram of a high voltage connector according to an embodiment of the present disclosure. As shown in FIG. 1, the high voltage connector includes a first connection part and a second connection part. The first connection part is provided with a first power pin module and a first signal pin module, and the second connection part is provided with a second power pin module and a second signal pin module. The first connection part may be fixed on a first PCB where a first power supply is located, the second connection part may be fixed on a second PCB where the load is located, and the first connection part is connected to the second connection part in a pluggable manner.

Specifically, a first terminal of the first power pin module is configured to be connected to the first power supply through a switch module, and a second terminal of the first power pin module is connected to a first terminal of the second power pin module. A first terminal of the first signal pin module is configured to be connected to a driving circuit of the switch module, and a second terminal of the first signal pin module is connected to a first terminal of the second signal pin module. A length of a signal pin in the first signal pin module is less than a length of a power pin in the first power pin module. A second terminal of the second power pin module is configured to be connected to the load, and second terminals of all signal pins in the second signal pin module are directly connected. A length of the signal pin in the second signal pin module is less than a length of a power pin in the second power pin module.

It should be noted that, based on the application scenario of the high voltage connector, the first power supply may be a direct-current power supply or an alternating-current power supply. For example, the first power supply may be a three-phase alternating-current power supply that outputs three-phase alternating-current power, or the first power supply may be a direct-current bus that transmits direct-current power. The number of power pins in the first power pin module may be configured according to a phase line connected to the first power supply. For example, in a case that the first power supply is a three-phase alternating-current power supply and the first power supply transmits three-phase alternating-current power using a three-phase three-wire system, the first power pin module may include power pins connected to all phase lines in one-to-one correspondence.

In practice, the first connection part may be fixed on the first PCB board where the first power supply is located, and the second connection part may be fixed on the second PCB board where the load is located. The second terminal of the first power pin module and the second terminal of the first signal pin module may serve as an external interface of the first connection part. The first terminal of the second power pin module and the first terminal of the second signal pin module may serve as the external interface of the second connection part. The first connection part and the second connection part may be connected with each other in a pluggable manner through the external interfaces described above.

In a possible implementation, the first connection part may be connected to the first PCB board in a pluggable manner, that is, the first PCB board is provided with a socket that is connected to the first terminal of the first power pin module and the first terminal of the first signal pin module in a pluggable manner. Similarly, the second connection part may also be connected to the second PCB board in a pluggable manner. That is, the second PCB board is provided with a socket that is connected to the second terminal of the second power pin module and the second terminal of the second signal pin module in a pluggable manner.

By adopting the high voltage connector shown in FIG. 1, when the first connection part is connected to the second connection part in a pluggable manner, since the length of the signal pin in the first signal pin module is less than the length of the power pin in the first power pin module, and the length of the signal pin in the second signal pin module is less than the length of the power pin in the second power pin module, the first power pin module is connected to the second power pin module first to close the high-power main circuit, and then the first signal pin module and the second signal pin module are connected and form a loop with the driving circuit of the switch module to drive the switch module to be turned on, so as to implement the electrical connection of the main circuit. The delay drive of the electrical connection of the main circuit is implemented based on the length difference between pins, ensuring that the high voltage connector is powered on after being connected firmly, thereby realizing safe connection of the device. When the first connection part is disconnected from the second connection part, since the length of the signal pin in the first signal pin module is less than the length of the power pin in the first power pin module, and the length of the signal pin in the second signal pin module is less than the length of the power pin in the second power pin module, the first signal pin module is disconnected from the second signal pin module first, the driving circuit controls the switch module to break the electrical connection of the main circuit, and then the connection of the main circuit where no current flows through is broke by the first power pin module. The power-off of the switch module is implemented based on the length difference between the pins, rather than the power-off of the high voltage connector by directly unplugging, thus preventing the generation of arc on the high voltage connector and ensuring the safe power-off of the system.

Combined with the structure of the high voltage connector, the process of realizing the closing and breaking of the main circuit through the high voltage connector is illustrated in detail as follows.

In practice, since the switch control components of the switch module are generally powered by direct current, the first signal pin module includes the first signal pin a1 and the second signal pin a2, and the second signal pin module includes the third signal pin a3 and the fourth signal pin a4.

Specifically, referring to FIG. 2, a first terminal of the first signal pin a1 is configured to be connected to the driving circuit of the switch module, and a second terminal of the first signal pin a1 is connected to the second signal pin module. A first terminal of the second signal pin a2 is configured to be connected to the driving circuit of the switch module, and a second terminal of the second signal pin a2 is connected to the second signal pin module. A first terminal of the third signal pin a3 is connected to the second terminal of the first signal pin a1, and a second terminal of the third signal pin a3 is connected to a second terminal of the fourth signal pin a4. A first terminal of the fourth signal pin a4 is connected to the second terminal of the second signal pin a2. The first terminal of the first signal pin a1 and the first terminal of the second signal pin a2 form the first terminal of the first signal pin module, and the second terminal of the first signal pin a1 and the second terminal of the second signal pin a2 form the second terminal of the first signal pin module. The first terminal of the third signal pin a3 and the first terminal of the fourth signal pin a4 form the first terminal of the second signal pin module, and the second terminal of the third signal pin a3 and the second terminal of the fourth signal pin a4 form the second terminal of the second signal pin module.

In practice, the first power pin module includes first power pins one-to-one corresponding to all phase lines connected to the first power supply, and the second power pin module includes second power pins one-to-one corresponding to all power ports of the load. The number of the first power pins in the first power pin module is the same as the number of the second power pins in the second power pin module.

It should be noted that the high voltage connector are provided with different number of power pins when being connected to different power supplies. To facilitate understanding of the solutions protected in the present disclosure, a specific example of the high voltage connector is described when the first power supply is implemented by a three-phase alternating-current power supply.

Referring to FIG. 3, FIG. 3 is a schematic structural diagram when the first power supply connected to the high voltage connector is implemented by a three-phase alternating-current power supply. As shown in FIG. 3, ports of the three-phase alternating-current power supply configured to output A-phase alternating-current power, B-phase alternating-current power, and C-phase alternating-current power are respectively connected to the switch module through the phase lines L1 to L3. The first power pin module includes three first power pins b1 to b3 configured to be connected to the phase lines, and the second power pin module includes three second power pins b4 to b6 configured to be connected to the power ports of the load. The switch module is connected to first terminals of the three first power pins b1 to b3, the first terminal of the first signal pin a1 is connected to a positive terminal of a second power supply VCC through a coil of a relay KM, and the first terminal of the second signal pin a2 is connected to a negative terminal of the second power supply VCC. Second terminals of the three second power pins b4 to b6 are respectively connected to the three power ports of the load, and the second terminal of the third signal pin a3 is directly connected to the second terminal of the fourth signal pin a4.

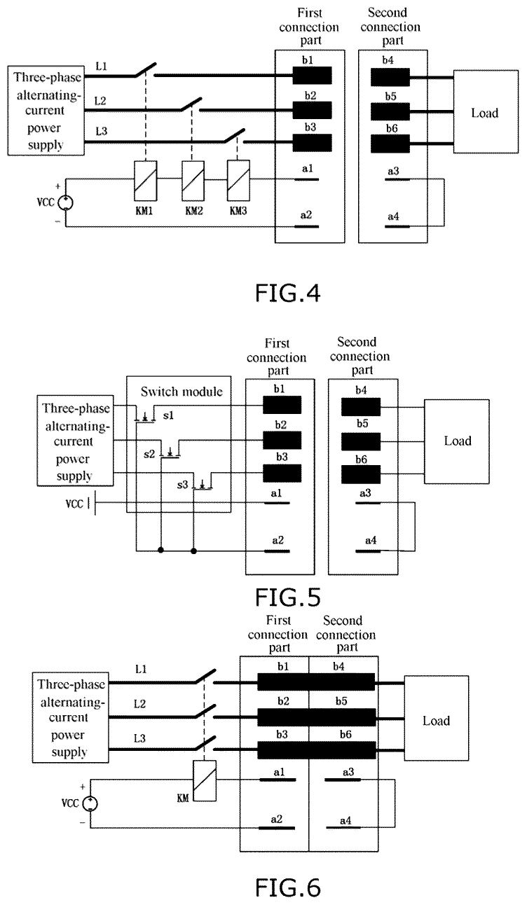

It should be noted that in the schematic diagram of the connection of the high voltage connector shown in FIG. 3, the switch module implemented by three pairs of normally open contacts of the same relay is taken as an example for illustration. In practice, referring to FIG. 4, the above switch module may also be implemented by three pairs of normally open contacts, where the three pairs of normally open contact are selected from three different relays KM1-KM3. The switch module may further be implemented by other components with switching function. For example, referring to FIG. 5, the switch module may be implemented by three switching transistors s1 to s3 commonly used in the industry. In this case, the second power supply VCC is connected to the first terminal of the first signal pin a1, and the control terminals of the switching transistors are connected to the first terminal of the second signal pin a2.

It should be noted that in the schematic diagram of the connection of the high voltage connector shown in FIG. 3, the driving circuit including the second power supply VCC is taken as an example for illustration. In practice, the driving circuit may further be implemented by other drive topologies commonly used in the industry, which is not introduced in the present disclosure.

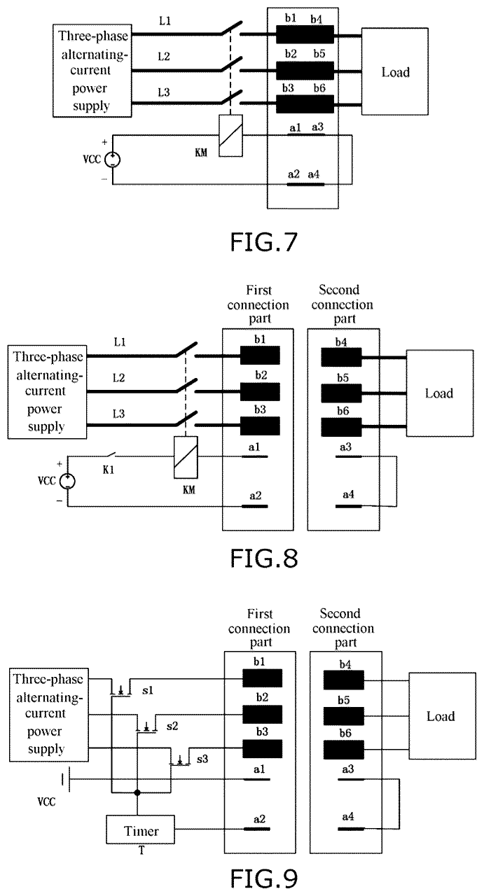

By adopting the high voltage connector shown in FIG. 3, since the length of the signal pin is less than the length of the power pin, when the first connection part is connected to the second connection part in a pluggable manner, as shown in FIG. 6, the power pins b1 to b3 in the first connection part and the power pins b4 to b6 in the second connection part are connected first to close the main circuit. In this case, the signal pins are still in the disconnected state. When the power pins in the first connection part and the power pins in the second connection part are firmly connected with each other, as shown in FIG. 7, the two signal pins a1 and a2 in the first connection part are connected to the two signal pins a3 and a4 in the second connection part in one-to-one correspondence. In this case, the second power supply VCC supplies power to the coil of the relay KM. After the relay KM is powered on, the main contact is closed to implement the electrical connection between the three-phase alternating-current power supply and the load, thereby supplying power to the load. The power pins corresponding to the main circuit are connected first, and then the switches in the switch module are turned on, effectively avoiding the situation of poor contact caused by powering on when the connection between the power pins is unstable.

Continuing to refer to FIG. 3, since the length of the signal pin is less than the length of the power pin, when the first connection part is disconnected from the second connection part, the connection state between the first connection part and the second connection part is still as shown in FIG. 6. The signal pins a1 and a2 in the first connection part and the signal pins a3 and a4 in the second connection part are disconnected first. In this case, the power supply path of the coil of the relay KM is disconnected, the relay KM is powered off to control the switch module to be turned off for disconnecting the three-phase alternating-current power supply from the first connection part, so as to break the main circuit, thus avoiding powering off by directly unplugging the high voltage connector and ensuring the safe power-off of the system.

In practice, in order to ensure that the main circuit can be safely broken in case of malfunction, as shown in FIG. 8, a mechanical switch K1, for example, a push-button switch, may be arranged between the second power supply VCC and the signal pin in the first connection part. When a system malfunction is detected, the operator may control the switch module to break the connection of the main circuit through the mechanical switch K1, so as to protect the safety of the system.

Referring to the high voltage connectors shown in FIG. 2 to FIG. 8, the time delay is mainly implemented by configuring different lengths for the power pins and the signal pins, thus achieving safe connection and safe power-off. In order to prevent transient voltage fluctuations or unstable states during the connector insertion process, a time-delay device may further be configured to further increase the delay time.

In an example, the time-delay device may be a timer, as shown in FIG. 9. The second power supply VCC is connected to the first signal pin module through timer T, and an output terminal of the timer is connected to the control terminals of the switching transistors s1 to s3 in the switch module. When the signal pins in the first connection part are connected to the signal pins in the second connection part, the timer starts to time after it is powered on. When the timing time is reached, the timer outputs a control signal of a corresponding electrical level to the control terminals of the switching transistors, so as to drive the switching transistors to turn on, thus implementing the electrical connection of the main circuit.

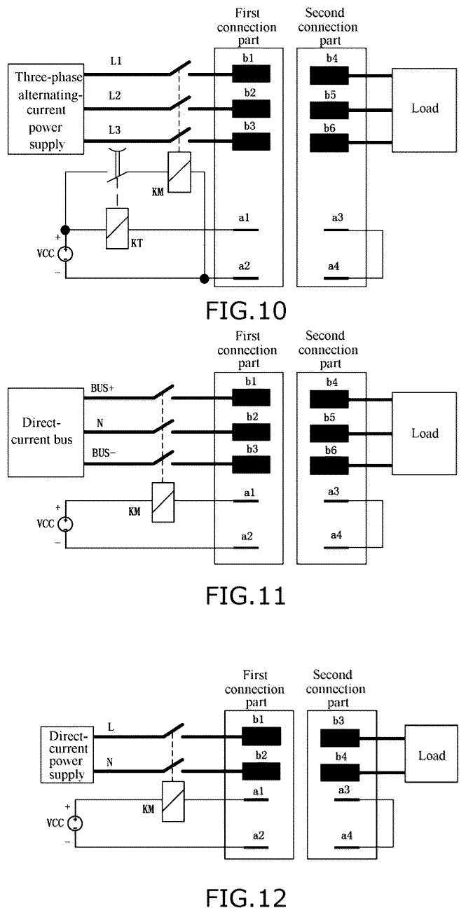

In another example, the time-delay device may be a time-delay relay KT, as shown in FIG. 10. The second power supply VCC is connected to the first signal pin module through the time-delay relay KT, and the delay contact of the time-delay relay KT is connected between the second power supply VCC and the coil of the relay KM in the switch module. When the signal pins in the first connection part are connected to the signal pins in the second connection part, the coil of the time-delay relay KT is powered on. When the delay time of the time-delay relay KT is reached, the delay contact is closed, and the relay KM that controls the connection of the main circuit is powered on, thereby implementing the electrical connection of the main circuit.

It should be noted that the timing time of the timer or the delay time of the time-delay relay may be configured according to the application scenario of the high voltage connector. For example, the delay time may be set to several milliseconds to tens of milliseconds to adapt to the stability requirements under different working conditions.

The schematic diagrams of the structure and connection of the high voltage connector are described above, in a case that the first power supply connected with the high voltage connector is a three-phase alternating-current power supply. In practice, the high voltage connector may further be applied to the power supply system with different power supplies as electric power supplies. For example, as shown in FIG. 11 and FIG. 12, which are the schematic diagrams of the structure and connection of the high voltage connector when the first power supply is implemented by direct-current power supplies of different types. Alternatively, the first power supply may also be power supplies of different types commonly used in the industry, which is not limited in the present disclosure.

Based on the same conception, a power supply apparatus is further provided according to embodiments of the present disclosure. The power supply apparatus includes a first power supply, a switch module, a driving circuit and the high voltage connector described above.

Specifically, the first power supply is connected to the high voltage connector through the switch module. The high voltage connector is connected to the driving circuit. The driving circuit is connected to the switch module and is configured to control the turn on and off of the switch module.

In a possible implementation, the switch module includes a plurality of relays or a plurality of switching transistors.

In a possible implementation, the driving circuit includes a second power supply. The second power supply is connected to control terminals of the switching transistors or coils of the relays in the switch module through the first signal pin module.

In a possible implementation, the power supply apparatus further includes a timer. The second power supply is connected to the first signal pin module through the timer, and an output terminal of the timer is connected to the control terminals of the switching transistor in the switch module.

In a possible implementation, the power supply apparatus further includes a time-delay relay. The second power supply is connected to the first signal pin module through the time-delay relay, and a delay contact of the time-delay relay is connected between the second power supply and the coil of the relay in the switch module.

In a possible implementation, the power supply apparatus further includes a mechanical switch connected between the second power supply and the first signal pin module.

It should be noted that the structure and connection mode of each component in the power supply apparatus may be referred to the above related introduction, which will not be repeated here.

In various embodiments of the present disclosure, unless otherwise specified or there is a logical conflict, the terms and/or descriptions in different embodiments are consistent and may be cross-referenced with each other. The technical features in different embodiments may be combined to form new embodiments according to their inherent logical relationships.

Apparently, those skilled in the art may make various modifications and variations to the present disclosure without departing from the protection scope of the present disclosure. If these modifications and variations to the present disclosure fall within the scope of the claims and equivalent technologies thereof, the present disclosure is also intended to include these modifications and variations.

What is claimed is:

1. A high voltage connector, characterized by comprising a first connection part provided with a first power pin module and a first signal pin module, and a second connection part provided with a second power pin module and a second signal pin module, wherein
the first connection part is connected to the second connection part in a pluggable manner;
a first terminal of the first power pin module is configured to be connected to a first power supply through a switch module, a second terminal of the first power pin module is connected to a first terminal of the second power pin module, a first terminal of the first signal pin module is configured to be connected to a driving circuit of the switch module, a second terminal of the first signal pin module is connected to a first terminal of the second signal pin module, and a length of a signal pin in the first signal pin module is less than a length of a power pin in the first power pin module; and
a second terminal of the second power pin module is configured to be connected to a load, second terminals of all signal pins in the second signal pin module are directly connected, a length of the signal pin in the second signal pin module is less than a length of a power pin in the second power pin module.

2. The high voltage connector according to claim 1, characterized in that the first signal pin module comprises a first signal pin and a second signal pin;
a first terminal of the first signal pin is configured to be connected to the driving circuit of the switch module, and a second terminal of the first signal pin is connected to the second signal pin module; and
a first terminal of the second signal pin is configured to be connected to the driving circuit of the switch module, and a second terminal of the second signal pin is connected to the second signal pin module,
wherein the first terminal of the first signal pin and the first terminal of the second signal pin form the first terminal of the first signal pin module, and the second terminal of the first signal pin and the second terminal of the second signal pin form the second terminal of the first signal pin module.

3. The high voltage connector according to claim 2, characterized in that the second signal pin module comprises a third signal pin and a fourth signal pin;
a first terminal of the third signal pin is connected to the second terminal of the first signal pin, and a second terminal of the third signal pin is connected to a second terminal of the fourth signal pin; and
a first terminal of the fourth signal pin is connected to the second terminal of the second signal pin,
wherein the first terminal of the third signal pin and the first terminal of the fourth signal pin form the first terminal of the second signal pin module, and the second terminal of the third signal pin and the second terminal of the fourth signal pin form the second terminal of the second signal pin module.

4. The high voltage connector according to claim 1, characterized in that the first power pin module comprises first power pins one-to-one corresponding to all phase lines connected to the first power supply, the second power pin module comprises second power pins one-to-one corresponding to all power ports of the load, and the number of the first power pins in the first power pin module is the same as the number of the second power pins in the second power pin module.

5. The high voltage connector according to claim 1, characterized in that the first connection part is located on a first PCB board where the first power supply is located, and the second connection part is located on a second PCB board where the load is located.

6. A power supply apparatus, characterized by comprising a first power supply, a switch module, a driving circuit and the high voltage connector according to claim 1, wherein
the first power supply is connected to the high voltage connector through the switch module;
the high voltage connector is connected to the driving circuit; and
the driving circuit is connected to the switch module and is configured to control turn on and off of the switch module.

7. The power supply apparatus according to claim 6, characterized in that the switch module comprises a plurality of relays or a plurality of switching transistors.

8. The power supply apparatus according to claim 7, characterized in that the driving circuit comprises a second power supply, and the second power supply is connected to control terminals of the switching transistors or coils of the relays in the switch module through the first signal pin module.

9. The power supply apparatus according to claim 8, characterized in that the power supply apparatus further comprises a timer, wherein the second power supply is connected to the first signal pin module through the timer, and an output terminal of the timer is connected to the control terminals of the switching transistors in the switch module.

10. The power supply apparatus according to claim 8, characterized in that the power supply apparatus further comprises a time-delay relay, wherein the second power supply is connected to the first signal pin module through the time-delay relay, and a delay contact of the time-delay relay is connected between the second power supply and the coils of the relays in the switch module.

11. The power supply apparatus according to claim 8, characterized in that the power supply apparatus further comprises a mechanical switch connected between the second power supply and the first signal pin module.
